(19) United States
(12) Patent Application Publication
(10) Pub. No.: US 2023/0127380 A1
(43) Pub. Date: Apr. 27, 2023

(54) METHODS AND SYSTEMS FOR COLORIZING MEDICAL IMAGES

(71) Applicant: GE Precision Healthcare LLC, Milwaukee, WI (US)

(72) Inventors: Ronen Ozer, Haifa (IL); Dani Pinkovich, Atlit (IL)

(21) Appl. No.: 17/451,808

(22) Filed: Oct. 21, 2021

(51) Int. Cl. G06T 11/00; G06T 7/11

(52) U.S. Cl. CPC G06T 11/001; G06T 7/11; G06T 2207/10132; G06T 2210/41

(57) ABSTRACT

Various methods and systems are provided for annotating medical images such as ultrasound images. For example, a method for annotating a medical image includes segmenting a region of interest in the medical image, annotating the medical image by separately adjusting a value of each pixel in the region of interest, and outputting the annotated medical image to a display. As a further example adjusting the value of each pixel may include overlaying the pixel with color, colorizing the pixel based on the value of the pixel, and/or intensifying the value of the pixel.

### FIELD

Embodiments of the subject matter disclosed herein relate to annotating ultrasound images.

### BACKGROUND

An ultrasound imaging system typically includes an ultrasound probe that is applied to a patient’s body and a workstation or device that is operably coupled to the probe. During a scan, the probe may be controlled by an operator of the system and is configured to transmit and receive ultrasound signals that are processed into an ultrasound image by the workstation or device. The workstation or device may show the ultrasound images as well as a plurality of user-selectable inputs through a display device. The operator or other user may interact with the workstation or device to analyze the images displayed on and/or select from the plurality of user-selectable inputs. The workstation or device may be able to annotate the ultrasound images. For example, current annotation techniques of the ultrasound images may include circling, highlighting, and/or overlaying a region of interest.

### BRIEF DESCRIPTION

In one embodiment, a method for annotating a medical image, includes segmenting a region of interest in the medical image, annotating the medical image by separately adjusting a value of each pixel in the region of interest, and outputting the annotated medical image to a display. Annotating the medical image further includes a colorize factor that defines an amount of colorization to apply to a given pixel in the region of interest, increasing a contrast between pixels in the region of interest, and/or transforming each pixel in the region of interest from a grayscale image power to a color mode image power.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will be better understood from reading the following description of non-limiting embodiments, with reference to the attached drawings, wherein below:

FIG. 1 shows a block schematic diagram of an ultrasound imaging system, according to an embodiment;

FIG. 2 is a schematic diagram illustrating an image processing system for detecting and overlaying, colorizing, and/or highlighting regions of interest in medical images, according to embodiment;

FIG. 3 shows a flow chart of an example method for detecting and overlaying, colorizing, and/or highlighting regions of interest in medical images, according to an embodiment;

FIG. 4 shows an example of an unaltered ultrasound image;

FIG. 5A shows an example of an ultrasound image with a 20% overlay;

FIG. 5B shows an example of an ultrasound image with a 50% overlay;

FIG. 5C shows an example of an ultrasound image with an 80% overlay;

FIG. 6A shows an example of an ultrasound image with a 20% colorization;

FIG. 6B shows an example of an ultrasound image with a 50% colorization;

FIG. 6C shows an example of an ultrasound image with a 100% colorization;

FIG. 6D shows an example of an ultrasound image with a 150% colorization;

FIG. 7A shows an example of an ultrasound image with a 50% highlight;

FIG. 7B shows an example of an ultrasound image with a 100% highlight; and

FIG. 7C shows an example of an ultrasound image with a 50% highlight and a 100% colorization.

### DETAILED DESCRIPTION

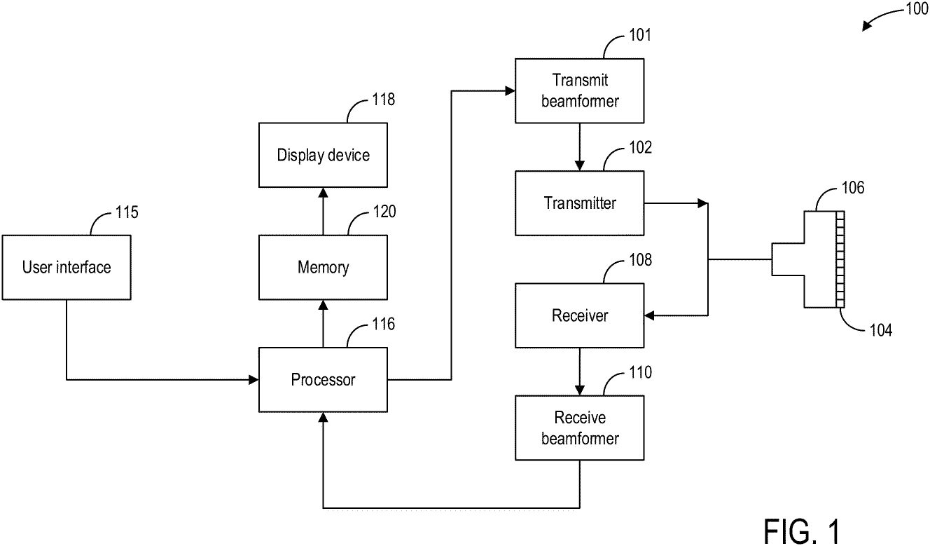

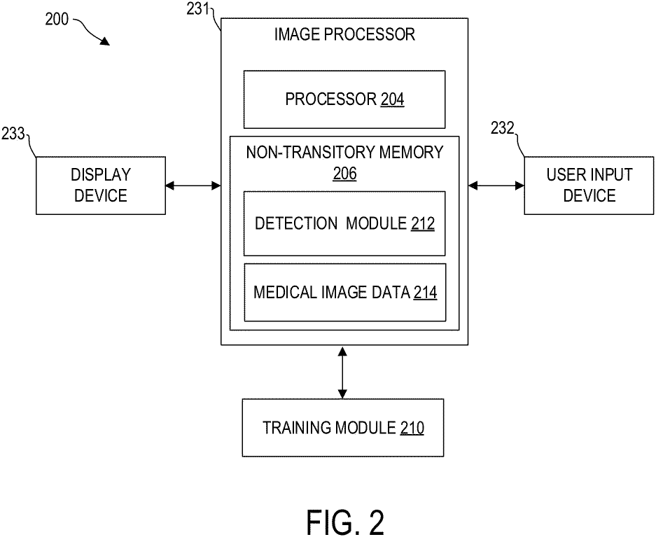

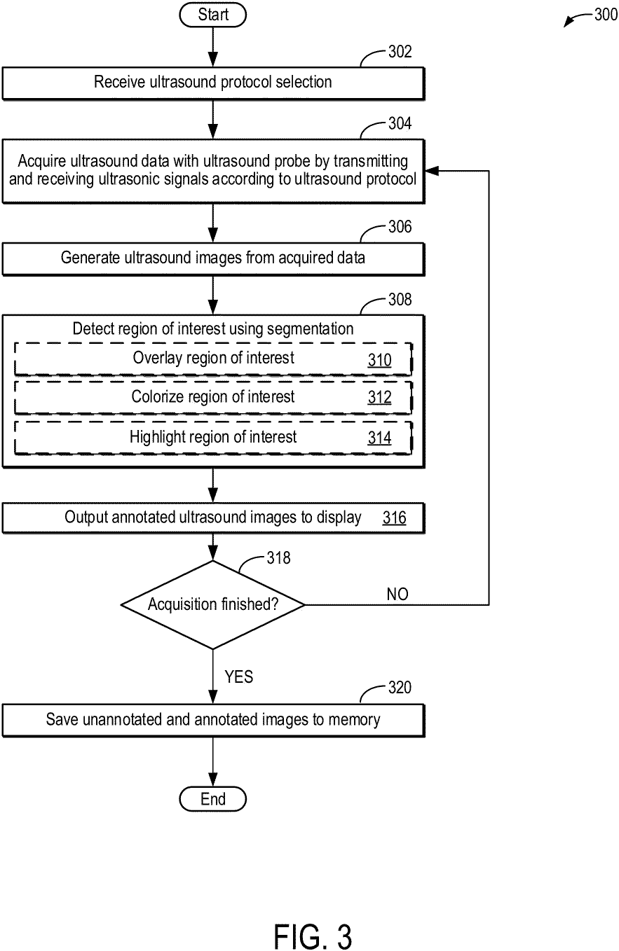

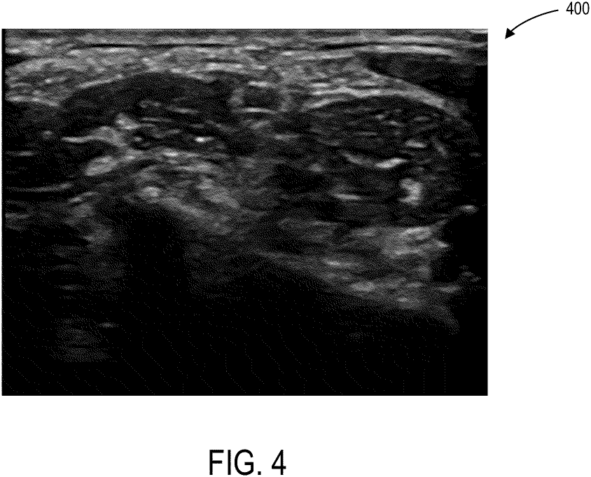

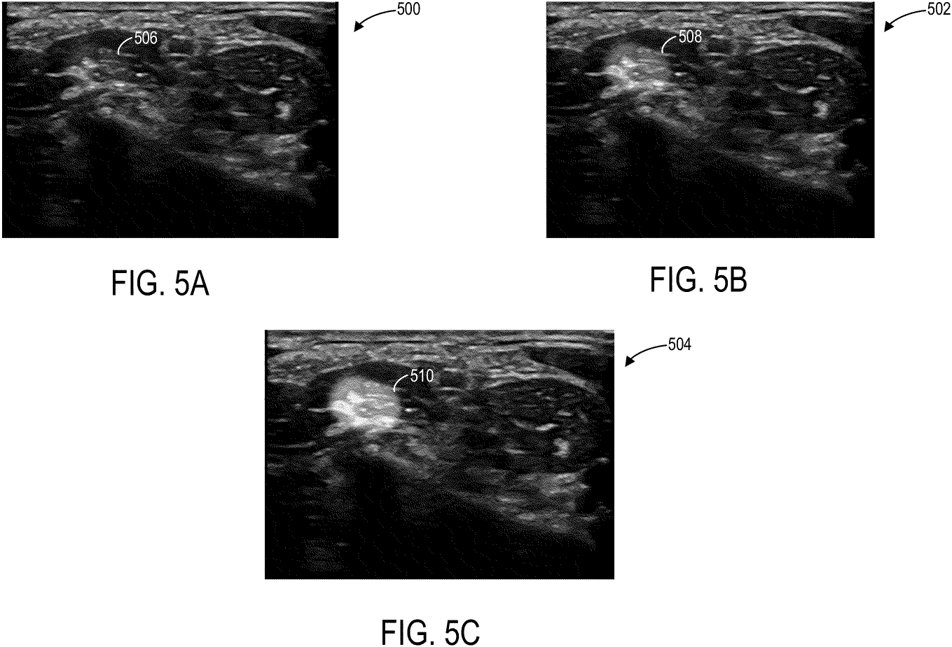

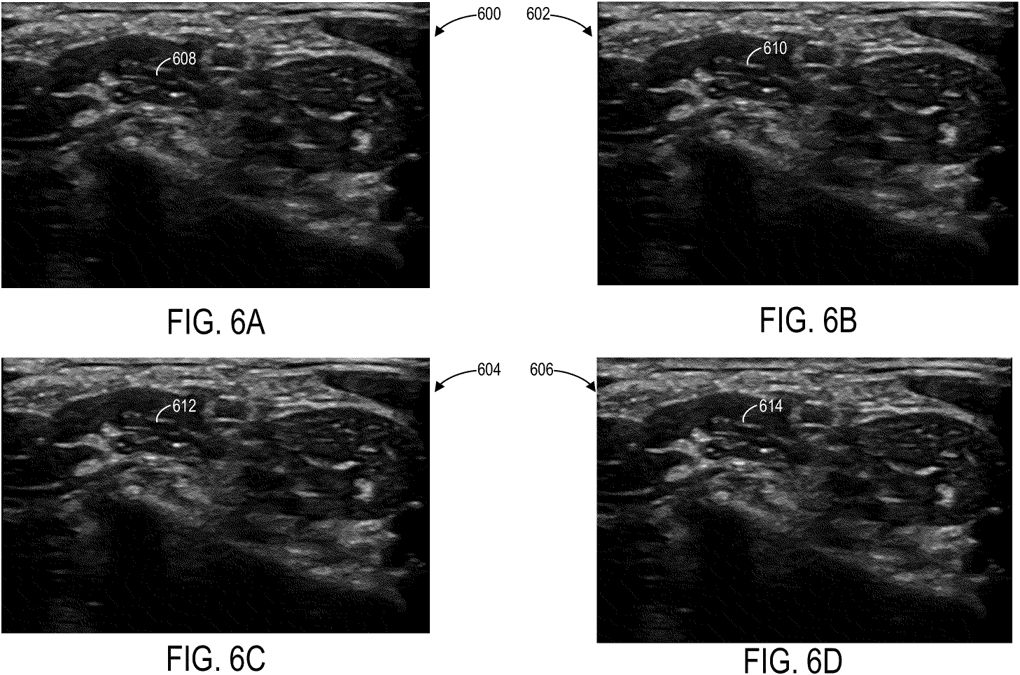

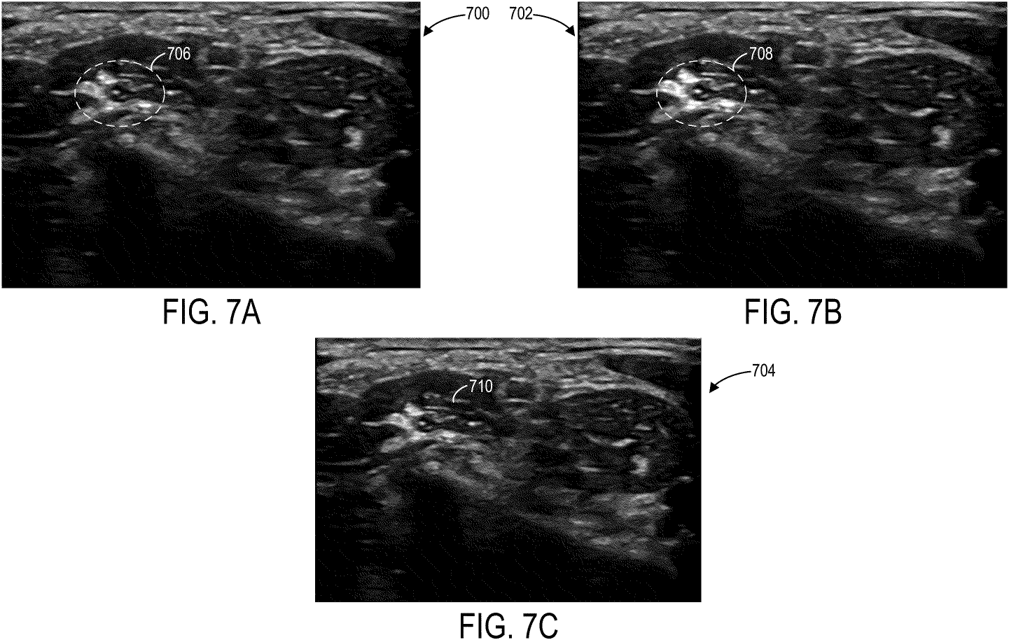

Embodiments of the present disclosure will now be described, by way of example, with reference to the FIGS. 1-7C, which relate to various embodiments for annotating medical imaging data acquired by an imaging system, such as the ultrasound imaging system shown in FIG. 1. As the processes described herein may be applied to pre-processed imaging data and/or to processed images, the term “image” is generally used throughout the disclosure to denote both pre-processed and partially-processed image data (e.g., pre-beamformed RF or I/Q data, pre-scan converted RF data) as well as fully processed images (e.g., scan converted and filtered images ready for display). An example image processing system that may be used to detect regions of interest desired to be annotated is shown in FIG. 2. The image processing system may employ image processing techniques and one or more algorithms, such as segmentation, to detect the region of interest and output medical images that are annotated by colorizing, highlighting, and/or overlaying the region of interest to an operator, such as according to the method of FIG. 3. An ultrasound medical image without annotations is shown in FIG. 4 so that it may be used as a comparison to the annotated ultrasound medical images shown in FIGS. 5A-7C. FIGS. 5A-5C show examples of annotating a region of interest (e.g., a nerve) by overlaying colors onto the ultrasound medical image. Each of FIGS. 5A-5C show a different percentage of applying the overlaying colors to the ultrasound medical image. FIGS. 6A-6D show examples of annotating the region of interest by colorizing individual pixels identified as the region of interest. FIGS. 7A and 7B show an example of annotating a medical image by highlighting the region of interest, while FIG. 7C shows a combination of highlighting and colorizing the region of interest of the medical image.

Advantages that may be realized in the practice of some embodiments of the described systems and techniques are that colorizing a region of interest of a medical image attracts attention to the region of interest without losing the contrast of the original image, which may occur when applying the currently used techniques of overlaying color onto the region of interest. As an example, overlaying color onto the region of interest may obscure original details of the medical image, which may interfere with detection of an anomality. Furthermore, overlaying color and colorization may bring too much attention to a region of interest and it may be instead desired to annotate the region of interest by highlighting, which may amplify the contrast of the region of interest without adding color to the image.

Referring now to FIG. 1, a schematic diagram of an ultrasound imaging system 100 in accordance with an embodiment of the disclosure is shown. However, it may be understood that embodiments set forth herein may be implemented using other types of medical imaging modalities (e.g., magnetic resonance imaging, computed tomography, positron emission tomography, and so on). The ultrasound imaging system 100 includes a transmit beamformer 101 and a transmitter 102 that drives elements (e.g., transducer elements) 104 within a transducer array, herein referred to as a probe 106, to emit pulsed ultrasonic signals (referred to herein as transmit pulses) into a body (not shown). According to an embodiment, the probe 106 may be a one-dimensional transducer array probe. However, in some embodiments, the probe 106 may be a two-dimensional matrix transducer array probe. The transducer elements 104 may be comprised of a piezoelectric material. When a voltage is applied to the piezoelectric material, the piezoelectric material physically expand and contract, emitting an ultrasonic spherical wave. In this way, the transducer elements 104 may convert electronic transmit signals into acoustic transmit beams.

After the elements 104 of the probe 106 emit pulsed ultrasonic signals into a body (of a patient), the pulsed ultrasonic signals are back-scattered from structures within an interior of the body, like blood cells or muscular tissue, to produce echoes that return to the elements 104. The echoes are converted into electrical signals, or ultrasound data, by the elements 104, and the electrical signals are received by a receiver 108. The electrical signals representing the received echoes are passed through a receive beamformer 110 that performs beamforming and outputs ultrasound data, which may be in the form of a radiofrequency (RF) signal. Additionally, the transducer elements 104 may produce one or more ultrasonic pulses to form one or more transmit beams in accordance with the received echoes.

According to some embodiments, the probe 106 may contain electronic circuitry to do all or part of the transmit beamforming and/or the receive beamforming. For example, all or part of the transmit beamformer 101, the transmitter 102, the receiver 108, and the receive beamformer 110 may be positioned within the probe 106. The terms “scan” or “scanning” may also be used in this disclosure to refer to acquiring data through the process of transmitting and receiving ultrasonic signals. The term “data” may be used in this disclosure to refer to one or more datasets acquired with an ultrasound imaging system.

A user interface 115 may be used to control operation of the ultrasound imaging system 100, including to control the input of patient data (e.g., patient medical history), to change a scanning or display parameter, to initiate a probe repolarization sequence, and the like. The user interface 115 may include one or more of a rotary element, a mouse, a keyboard, a trackball, hard keys linked to specific actions, soft keys that may be configured to control different functions, and a graphical user interface displayed on a display device 118. In some embodiments, the display device 118 may include a touch-sensitive display, and thus, the display device 118 may be included in the user interface 115.

The ultrasound imaging system 100 also includes a processor 116 to control the transmit beamformer 101, the transmitter 102, the receiver 108, and the receive beamformer 110. The processor 116 is in electronic communication (e.g., communicatively connected) with the probe 106. As used herein, the term “electronic communication” may be defined to include both wired and wireless communications. The processor 116 may control the probe 106 to acquire data according to instructions stored on a memory of the processor and/or a memory 120. As one example, the processor 116 controls which of the elements 104 are active and the shape of a beam emitted from the probe 106. The processor 116 is also in electronic communication with the display device 118, and the processor 116 may process the data (e.g., ultrasound data) into images for display on the display device 118. The processor 116 may include a central processing unit (CPU), according to an embodiment. According to other embodiments, the processor 116 may include other electronic components capable of carrying out processing functions, such as a digital signal processor, a field-programmable gate array (FPGA), or a graphic board. According to other embodiments, the processor 116 may include multiple electronic components capable of carrying out processing functions. For example, the processor 116 may include two or more electronic components selected from a list of electronic components including: a central processor, a digital signal processor, a field-programmable gate array, and a graphic board. According to another embodiment, the processor 116 may also include a complex demodulator (not shown) that demodulates RF data and generates raw data. In another embodiment, the demodulation can be carried out earlier in the processing chain.

The processor 116 is adapted to perform one or more processing operations according to a plurality of selectable ultrasound modalities on the data. In one example, the data may be processed in real-time during a scanning session as the echo signals are received by receiver 108 and transmitted to processor 116. For the purposes of this disclosure, the term “real-time” is defined to include a procedure that is performed without any intentional delay (e.g., substantially at the time of occurrence). For example, an embodiment may acquire images at a real-time rate of 7-20 frames/sec. The ultrasound imaging system 100 may acquire two-dimensional (2D) data of one or more planes at a significantly faster rate. However, it should be understood that the real-time frame-rate may be dependent on a length (e.g., duration) of time that it takes to acquire and/or process each frame of data for display. Accordingly, when acquiring a relatively large amount of data, the real-time frame-rate may be slower. Thus, some embodiments may have real-time frame-rates that are considerably faster than 20 frames/sec while other embodiments may have real-time frame-rates slower than 7 frames/sec.

In some embodiments, the data may be stored temporarily in a buffer (not shown) during a scanning session and processed in less than real-time in a live or off-line operation. Some embodiments of the disclosure may include multiple processors (not shown) to handle the processing tasks that are handled by the processor 116 according to the exemplary embodiment described hereinabove. For example, a first processor may be utilized to demodulate and decimate the RF signal while a second processor may be used to further process the data, for example, by augmenting the data as described further herein, prior to displaying an image. It should be appreciated that other embodiments may use a different arrangement of processors.

The ultrasound imaging system 100 may continuously acquire data at a frame-rate of, for example, 10 Hz to 30 Hz (e.g., 10 to 30 frames per second). Images generated from the data may be refreshed at a similar frame-rate on the display device 118. Other embodiments may acquire and display data at different rates. For example, some embodiments may acquire data at a frame-rate of less than 10 Hz or greater than 30 Hz depending on the size of the frame and the intended application. The memory 120 may store processed frames of acquired data. In an exemplary embodiment, the memory 120 is of sufficient capacity to store at least several seconds’ worth of frames of ultrasound data. The frames of data are stored in a manner to facilitate retrieval thereof according to its order or time of acquisition. The memory 120 may comprise any known data storage medium.

In various embodiments of the present disclosure, data may be processed in different mode-related modules by the processor 116 (e.g., B-mode, Color Doppler, M-mode, Color M-mode, spectral Doppler, elastography, tissue velocity imaging, strain, strain rate, and the like) to form 2D or three-dimensional (3D) images. When multiple images are obtained, the processor 116 may also be configured to stabilize or register the images. For example, one or more modules may generate B-mode, color Doppler, M-mode, color M-mode, color flow imaging, spectral Doppler, elastography, tissue velocity imaging (TVI), strain, strain rate, and the like, and combinations thereof. As one example, the one or more modules may process color Doppler data, which may include traditional color flow Doppler, power Doppler, high-definition (HD) flow Doppler, and the like. The image lines and/or frames are stored in memory and may include timing information indicating a time at which the image lines and/or frames were stored in memory. The modules may include, for example, a scan conversion module to perform scan conversion operations to convert the acquired images from beam space coordinates to display space coordinates. A video processor module may be provided that reads the acquired images from a memory and displays an image in real-time while a procedure (e.g., ultrasound imaging) is being performed on a patient. The video processor module may include a separate image memory, and the ultrasound images may be written to the image memory in order to be read and displayed by the display device 118.

Further, the components of the ultrasound imaging system 100 may be coupled to one another to form a single structure, may be separate but located within a common room, or may be remotely located with respect to one another. For example, one or more of the modules described herein may operate in a data server that has a distinct and remote location with respect to other components of the ultrasound imaging system 100, such as the probe 106 and the user interface 115. Optionally, the ultrasound imaging system 100 may be a unitary system that is capable of being moved (e.g., portably) from room to room. For example, the ultrasound imaging system 100 may include wheels or may be transported on a cart, or may comprise a handheld device.

For example, in various embodiments of the present disclosure, one or more components of the ultrasound imaging system 100 may be included in a portable, handheld ultrasound imaging device. For example, the display device 118 and the user interface 115 may be integrated into an exterior surface of the handheld ultrasound imaging device, which may further contain the processor 116 and the memory 120 therein. The probe 106 may comprise a handheld probe in electronic communication with the handheld ultrasound imaging device to collect raw ultrasound data. The transmit beamformer 101, the transmitter 102, the receiver 108, and the receive beamformer 110 may be included in the same or different portions of the ultrasound imaging system 100. For example, the transmit beamformer 101, the transmitter 102, the receiver 108, and the receive beamformer 110 may be included in the handheld ultrasound imaging device, the probe, and combinations thereof.

Turning now to FIG. 2, an example medical image processing system 200 is shown. In some embodiments, the medical image processing system 200 is incorporated into a medical imaging system, such as an ultrasound imaging system (e.g., the ultrasound imaging system 100 of FIG. 1), an MRI system, a CT system, a single-photon emission computed tomography (SPECT) system, etc. In some embodiments, at least a portion of the medical image processing system 200 is disposed at a device (e.g., an edge device or server) communicably coupled to the medical imaging system via wired and/or wireless connections. In some embodiments, the medical image processing system 200 is disposed at a separate device (e.g., a workstation) that can receive images from the medical imaging system or from a storage device that stores the images generated by the medical imaging system. The medical image processing system 200 may comprise an image processor 231, a user input device 232, and a display device 233. For example, the image processor 231 may be operatively/communicatively coupled to the user input device 232 and the display device 233.

The image processor 231 includes a processor 204 configured to execute machine-readable instructions stored in non-transitory memory 206. The processor 204 may be single core or multi-core, and the programs executed by the processor 204 may be configured for parallel or distributed processing. In some embodiments, the processor 204 may optionally include individual components that are distributed throughout two or more devices, which may be remotely located and/or configured for coordinated processing. In some embodiments, one or more aspects of the processor 204 may be virtualized and executed by remotely-accessible networked computing devices configured in a cloud computing configuration. In some embodiments, the processor 204 may include other electronic components capable of carrying out processing functions, such as a digital signal processor, a field-programmable gate array (FPGA), or a graphics board. In some embodiments, the processor 204 may include multiple electronic components capable of carrying out processing functions. For example, the processor 204 may include two or more electronic components selected from a plurality of possible electronic components, including a central processor, a digital signal processor, a field-programmable gate array, and a graphics board. In still further embodiments, the processor 204 may be configured as a graphical processing unit (GPU), including parallel computing architecture and parallel processing capabilities.

In the embodiment shown in FIG. 2, the non-transitory memory 206 stores a detection module 212 and medical image data 214. The detection module 212 includes one or more algorithms to process input medical images from the medical image data 214. Specifically, the detection module 212 may identify an anatomical feature within the medical image data 214. For example, the detection module 212 may include one or more image recognition algorithms, shape or edge detection algorithms, gradient algorithms, and the like to process input medical images. Additionally or alternatively, the detection module 212 may store instructions for implementing a neural network, such as a convolutional neural network, for detecting and quantifying anatomical irregularities captured in the medical image data 214. For example, the detection module 212 may include trained and/or untrained neural networks and may further include training routines, or parameters (e.g., weights and biases), associated with one or more neural network models stored therein. In some embodiments, the detection module 212 may evaluate the medical image data 214 as it is acquired in real-time. Additionally or alternatively, the detection module 212 may evaluate the medical image data 214 offline, not in real-time.

As an example, the identified anatomical feature of the medical image data 214 may include ultrasound images with nerves that are desired to be identified. Nerves within the medical image data 214 may be identified by the detection module 212 using a segmentation algorithm, for example. The segmentation algorithm may include identifying and annotating individual pixels of the medical image data 214. For example, the segmentation algorithm may identify that a pixel is located within a nerve and may label the pixel as a nerve. Furthermore, the segmentation algorithm may include a certainty of identification of the nerve. For example, the segmentation algorithm may, in addition to labeling the pixel as a nerve, label the pixel with an amount of certainty that the pixel is correctly identified. For example, the amount of certainty may be a percentage. Both annotations for the identification and the amount of certainty of the pixel may be in a mask that contains identification and amount of certainty for some or all of the pixels in the medical image data 214. Similarly labeled pixels within a given area may create a region of interest.

The image processor 231 may be communicatively coupled to a training module 210, which includes instructions for training one or more of the machine learning models stored in the detection module 212. The training module 210 may include instructions that, when executed by a processor, cause the processor to build a model (e.g., a mathematical model) based on sample data to make predictions or decisions regarding the detection and classification of anatomical features without the explicit programming of a conventional algorithm that does not utilize machine learning. In one example, the training module 210 includes instructions for receiving training data sets from the medical image data 214. The training data sets comprise sets of medical images, associated ground truth labels/images, and associated model outputs for use in training one or more of the machine learning models stored in the detection module 212. The training module 210 may receive medical images, associated ground truth labels/images, and associated model outputs for use in training the one or more machine learning models from sources other than the medical image data 214, such as other image processing systems, the cloud, etc. In some embodiments, one or more aspects of the training module 210 may include remotely-accessible networked storage devices configured in a cloud computing configuration. Further, in some embodiments, the training module 210 is included in the non-transitory memory 206. Additionally or alternatively, in some embodiments, the training module 210 may be used to generate the detection module 212 offline and remote from the image processing system 200. In such embodiments, the training module 210 may not be included in the image processing system 200 but may generate data stored in the image processing system 200. For example, the detection module 212 may be pre-trained with the training module 210 at a place of manufacture.

The non-transitory memory 206 further stores the medical image data 214. The medical image data 214 includes, for example, functional and/or anatomical images captured by an imaging modality, such as an ultrasound imaging system, an MRI system, a CT system, a PET system, etc. As one example, the medical image data 214 may include ultrasound images, such as nerve ultrasound images. Further, the medical image data 214 may include one or more of 2D images, 3D images, static single frame images, and multiframe cine-loops (e.g., movies).

In some embodiments, the non-transitory memory 206 may include components disposed at two or more devices, which may be remotely located and/or configured for coordinated processing. In some embodiments, one or more aspects of the non-transitory memory 206 may include remotely-accessible networked storage devices in a cloud computing configuration. As one example, the non-transitory memory 206 may be part of a picture archiving and communication system (PACS) that is configured to store patient medical histories, imaging data, test results, diagnosis information, management information, and/or scheduling information, for example.

The image processing system 200 may further include the user input device 232. The user input device 232 may comprise one or more of a touchscreen, a keyboard, a mouse, a trackpad, a motion sensing camera, or other device configured to enable a user to interact with and manipulate data stored within the image processor 231.

The display device 233 may include one or more display devices utilizing any type of display technology. In some embodiments, the display device 233 may comprise a computer monitor and may display unprocessed images, processed images, parametric maps, and/or exam reports. The display device 233 may be combined with the processor 204, the non-transitory memory 206, and/or the user input device 232 in a shared enclosure or may be a peripheral display device. The display device 233 may include a monitor, a touchscreen, a projector, or another type of display device, which may enable a user to view medical images and/or interact with various data stored in the non-transitory memory 206. In some embodiments, the display device 233 may be included in a smartphone, a tablet, a smartwatch, or the like.

It may be understood that the medical image processing system 200 shown in FIG. 2 is one non-limiting embodiment of an image processing system, and other imaging processing systems may include more, fewer, or different components without parting from the scope of this disclosure. Further, in some embodiments, at least portions of the medical image processing system 200 may be included in the ultrasound imaging system 100 of FIG. 1, or vice versa (e.g., at least portions of the ultrasound imaging system 100 may be included in the medical image processing system 200).

As used herein, the terms “system” and “module” may include a hardware and/or software system that operates to perform one or more functions. For example, a module or system may include or may be included in a computer processor, controller, or other logic-based device that performs operations based on instructions stored on a tangible and non-transitory computer readable storage medium, such as a computer memory. Alternatively, a module or system may include a hard-wired device that performs operations based on hard-wired logic of the device. Various modules or systems shown in the attached figures may represent the hardware that operates based on software or hardwired instructions, the software that directs hardware to perform the operations, or a combination thereof.

“Systems” or “modules” may include or represent hardware and associated instructions (e.g., software stored on a tangible and non-transitory computer readable storage medium, such as a computer hard drive, ROM, RAM, or the like) that perform one or more operations described herein. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations.

Turning to FIG. 3, a method 300 for colorizing, highlighting, and/or overlaying a region of interest on an ultrasound image is shown. Method 300 will be described for ultrasound images acquired using an ultrasound imaging system, such as ultrasound imaging system 100 of FIG. 1, although other ultrasound imaging systems may be used. Further, method 300 may be adapted to other imaging modalities. Method 300 may be implemented by one or more of the above described systems, including the ultrasound imaging system 100 of FIG. 1 and medical image processing system 200 of FIG. 2. As such, method 300 may be stored as executable instructions in non-transitory memory, such as the memory 120 of FIG. 1 and/or the non-transitory memory 206 of FIG. 2, and executed by a processor, such as the processor 116 of FIG. 1 and/or the processor 204 of FIG. 2. Further, in some embodiments, method 300 is performed in real-time, as the ultrasound images are acquired, while in other embodiments, at least portions of method 300 are performed offline, after the ultrasound images are acquired. For example, the processor may evaluate ultrasound images that are stored in memory even while the ultrasound system is not actively being operated to acquire images. Further still, at least parts of method 300 may be performed in parallel. For example, ultrasound data for a second image may be acquired while a first ultrasound image is generated, ultrasound data for a third image may be acquired while the first ultrasound image is analyzed, and so on.

At 302, method 300 includes receiving an ultrasound protocol selection. The ultrasound protocol may be selected by an operator (e.g., user) of the ultrasound imaging system via a user interface (e.g., the user interface 115). As one example, the operator may select the ultrasound protocol from a plurality of possible ultrasound protocols using a drop-down menu or by selecting a virtual button. Alternatively, the system may automatically select the protocol based on data received from an electronic health record (EHR) associated with the patient. For example, the EHR may include previously performed exams, diagnoses, and current treatments, which may be used to select the ultrasound protocol. Further, in some examples, the operator may manually input and/or update parameters to use for the ultrasound protocol. The ultrasound protocol may be a system guided protocol, where the system guides the operator through the protocol step-by-step, or a user guided protocol, where the operator follows a lab-defined or self-defined protocol without the system enforcing a specific protocol or having prior knowledge of the protocol steps.

Further, the ultrasound protocol may include a plurality of scanning sites (e.g., views), probe movements, and/or imaging modes that are sequentially performed. For example, the ultrasound protocol may include using real-time B-mode imaging with a convex, curvilinear, or linear ultrasound probe (e.g., the probe 106 of FIG. 1). In some examples, the ultrasound protocol may further include using dynamic M-mode.

At 304, method 300 includes acquiring ultrasound data with the ultrasound probe by transmitting and receiving ultrasonic signals according to the ultrasound protocol. Acquiring ultrasound data according to the ultrasound protocol may include the system displaying instructions on the user interface, for example, to guide the operator through the acquisition of the designated scanning sites. Additionally or alternatively, the ultrasound protocol may include instructions for the ultrasound system to automatically acquire some or all of the data or perform other functions. For example, the ultrasound protocol may include instructions for the user to move, rotate and/or tilt the ultrasound probe, as well as to automatically initiate and/or terminate a scanning process and/or adjust imaging parameters of the ultrasound probe, such as ultrasound signal transmission parameters, ultrasound signal receive parameters, ultrasound signal processing parameters, or ultrasound signal display parameters. Further, the acquired ultrasound data includes one or more image parameters calculated for each pixel or group of pixels (for example, a group of pixels assigned the same parameter value) to be displayed, where the one or more calculated image parameters include, for example, one or more of an intensity, velocity, color flow velocity, texture, graininess, contractility, deformation, and rate of deformation value.

At 306, method 300 includes generating ultrasound images from the acquired ultrasound data. For example, the signal data acquired during the method at 304 is processed and analyzed by the processor in order to produce an ultrasound image at a designated frame rate. The processor may include an image processing module that receives the signal data (e.g., image data) acquired at 304 and processes the received image data. For example, the image processing module may process the ultrasound signals to generate slices or frames of ultrasound information (e.g., ultrasound images) for displaying to the operator. In one example, generating the image may include determining an intensity value (e.g., a power value) for each pixel to be displayed based on the received image data (e.g., 2D or 3D ultrasound data). As such, the generated ultrasound images may be 2D or 3D depending on the mode of ultrasound being used (such as B-mode, M-mode, and the like). The ultrasound images will also be referred to herein as “frames” or “image frames.” Further, as an example, the generated ultrasound images may be in grayscale or may be in color. As another example, the generated ultrasound image may be mostly gray with tints of other colors (e.g., brown or blue). Certain areas may have color applied to the areas to show specific quality of those areas. For example, colors may be applied to blood vessels to show velocities inside the blood vessels.

Turning briefly to FIG. 4, an ultrasound image 400 generated by an ultrasound imaging system is shown. The generated ultrasound image 400 is not annotated and is shown in grayscale; however, in other examples, the ultrasound image 400 may be shown on a color scale. For example, each pixel is defined by a grayscale image power which indicates whiter regions of the ultrasound image 400 as increased intensity of the grayscale image power. As another example, darker regions (e.g., blacker regions) of the ultrasound image 400 may indicate a decreasing intensity of the grayscale image power in the darker regions. Further, the generated ultrasound image 400 may be displayed to an operator of the ultrasound imaging system.

At 308, method 300 includes detecting a region of interest using a segmentation algorithm. As an example, the region of interest may be nerves within the ultrasound image. Each pixel of the ultrasound image may be assigned an identification and a certainty of detection into a mask. For example, the segmentation algorithm may identify a pixel is located within a nerve (the region of interest) and label it as a nerve. Each pixel within the nerve may be labeled as such, which may then be segmented from other identified regions (regions that may not be the region of interest) such as blood, bones, etc. Furthermore, each pixel is assigned a mask value for a certainty of detection between a minimum value and a maximum value. For example, the mask values of certainty of detection may be percentages and thus a minimum value may be 0.0 and a maximum value may be 1.0, thus each pixel may be assigned a value for the certainty of detection between 0.0 and 1.0. As another example, the mask value increases toward the maximum value (e.g., 1.0) as the certainty of detection of the region of interest increases (e.g., more likely the pixel is within a nerve of the medical image increases). As a further example, the mask value decreases from the maximum value and to the minimum value as the certainty of detection of the region of interest decreases (e.g., less likely the pixel is within a nerve of the medical image). In some examples, the mask value for the certainty of detection may either only be 1 or 0.

Detecting the region of interest optionally includes overlaying the region of interest with color, as depicted at 310. For example, pixels within the region of interest may be transformed from a grayscale image power to a color mode image power using an algorithm. As another example, if the original image is in color the overlay may tint the region of interest to a color defined by a color map selected. For example, the color map may be created by an algorithm defining each pixel with a red, green, and blue vector, which may be combined to output a color onto the region of interest. As a result, of transforming from a grayscale image power to a color mode with the color mode defined by a red, green, and blue vector an overlay mask may be created. The overlay mask is applied to each pixel of the region of interest as defined by the mask value for the certainty of detection. For example, if a pixel has a maximum value or near maximum value (e.g., above 70% certainty) the overlay may be applied to the pixel. As another example, if a pixel has a minimum value or near minimum value (e.g., below 70% certainty) the overlay may not be applied to the pixel. As a further example, the amount of overlay applied to a pixel may be based on the mask value for the certainty of detection (e.g., a greater mask value for the certainty of detection results in more overlay applied).

Turning briefly to FIGS. 5A-5C, a first overlay image 500 is shown in FIG. 5A, a second overlay image 502 is shown in FIG. 5B, and a third overlay image 504 is shown in FIG. 5C. The first overlay image 500, second overlay image 502, and third overlay image 504, are ultrasound images produced from an ultrasound imaging system and are shown with a first region of interest 506, a second region of interest 508, and a third region of interest 510, respectively, where the region of interest is a nerve (e.g., the lighter areas) that is colored yellow using an overlay mask. In other examples, the overlay color may be other colors such as red, blue, green, etc.

The first region of interest 506, the second region of interest 508, and the third region of interest 510 are all located on the same area of the ultrasound image; however, a different value of an overlay mask is applied to the first region of interest 506, the second region of interest 508, and the third region of interest 510. For example, the first region of interest 506 has a 20% overlay, resulting in the region of interest to not be as intensely yellow as the second region of interest 508, which has a 50% overlay, or the third region of interest 510, which has an 100% overlay. Further, the overlay mask is added to first region of interest 506, the second region of interest 508, and the third region of interest 510 based on the mask value for certainty of detection. As a result, the region of interest may stand out in comparison to the remainder of the ultrasound image (e.g., an area of the ultrasound image that is not the region of interest) to an operator of the ultrasound imaging system, physician, etc. However, as exemplified in the third overlay image 504, the overlay mask may obscure original details of the ultrasound image due to the overlay reducing contrast between darker and lighter regions of the ultrasound image. Thus, it may be desired for other techniques that do not obscure originally details of the ultrasound image, such as a colorization mask, to be used alternatively or in addition to the overlay mask.

Returning to FIG. 3, detecting the region of interest optionally includes colorizing the region of interest, as depicted at 312. For example, colorizing of the region of interest, which is relative to the remainder of the medical image, may be achieved by applying a colorization mask to the pixels of the region of interest. The colorization mask may determine a color shift for each pixel in the region of interest based on the values of the certainty of detection mask of the region of interest at a given pixel. For example, as the value of the certainty of detection mask increases the color shift value increases. The color of each pixel in the region of interest may be determined by a target color vector that is a combination of a blue, red, and yellow color vector, creating a target highlighting color mask. Thus, the region of interest may be colorized as blue, red, yellow, or any combination of two or more of the three colors (e.g., a vector combination of blue and yellow creates a green color vector). As a result, each pixel may be defined by vector mathematics of the certainty of detection mask, the target highlighting color vector, and a grayscale map image power (e.g., the original intensity of each pixel determined by the ultrasound imaging system). The region of interest may then be transformed by the imaging processing device to the determined color shift of each pixel while the remainder of the medical image is maintained in grayscale.

Additionally, colorization maintains the original intensity of each pixel and shifts the color of each pixel to the target highlighting color. For example, very white values of the original grayscale image within the region of interest will shift to very yellow values if yellow is the desired target highlighting color, and dark values (e.g., gray) of the original grayscale image within the region of interest may shift to dark yellow values. The amount of shift is based on the certainty of detection mask. For example, if the mask value of the certainty of detection for a pixel is zero, the pixel may not be shifted yellow, and if the mask value of the certainty of detection for a pixel is above zero, the pixel may be shifted to yellow in equal proportions to the mask value of the certainty of detection.

Turning briefly to FIGS. 6A-6D, colorized ultrasound images generated from an ultrasound imaging system are shown. A first colorized image 600 is shown in FIG. 6A, a second colorized image 602 is shown in FIG. 6B, a third colorized image 604 is shown in FIG. 6C, and a fourth colorized image is shown in FIG. 6D. Each of the first colorized image 600, the second colorized image 602, the third colorized image 604, and the fourth colorized image 606 show ultrasound images of the same region with different colorization masks applied. For example, the first colorized image 600 shows a first region of interest 608 with a 20% colorization mask applied, the second colorized image 602 shows a second region of interest 610 with a 50% colorization mask applied, the third colorized image 604 shows a third region of interest 612 with a 100% colorization mask applied, and the fourth colorized image 606 shows a fourth region of interest 614 with a 150% colorization mask applied. As the amount of the colorization mask increases (e.g., increases in percentage) an intensity of the color (e.g., yellow) applied increases. For example, the intensity of the color of the first region of interest 608 is less than the intensity of the color for the fourth region of interest 614. Further, because a mask for certainty of detection is applied to the colorization masks, increasing intensity of color within an ultrasound image indicates an increasing certainty of the region of interest. Thus, the nerve will appear more yellow (or blue, red, green, etc. in other examples) within the region of interest while other components that are less likely to be a part of the nerve (e.g., blood) will appear less yellow. Thus, attention may be brought to the region of interest without obscuring original details of the ultrasound image.

Returning to FIG. 3, detecting the region of interest optionally includes highlighting the region of interest, as depicted at 314. Highlighting the region of interest includes increasing the pixel intensity of the grayscale image power (or in examples of color images a color scale image power) within the region of interest based on the certainty of detection mask applied to each pixel. For example, as the certainty of detection of a pixel increases the intensity of the pixel is increased. As a further example, a maximal highlighting value may occur at a maximum value of the certainty of detection. As a result, the region of interest may appear with a brighter intensity than the remainder of the ultrasound image.

Additionally or alternatively, for each pixel in the region of interest of the ultrasound image a total masking effect may be applied. For example, the total masking effect may include a boost factor that defines a gain increase and creates a boosted power value (e.g., amplifies the pixel intensity values), an attention factor that defines a strength of a total masking effect, a colorize factor that defines an image-dependent colorization effect, a highlight factor that defines an amount of overlay to add to the ultrasound image, and transforming the ultrasound image to red, green, and blue color space using a highlight map.

Turning briefly to FIGS. 7A and 7B, ultrasound images generated from an ultrasound imaging system are shown with a highlighting mask applied to regions of interest. A first highlighted image 700 is shown in FIG. 7A, and a second highlighted image 702 is shown in FIG. 7B. The first highlighted image 700 includes a first region of interest 706, which is circled by a dashed line. The second highlighted image 702 includes a second region of interest 708, which is circled by a dashed line. The dashed lines circling the first region of interest 706 and the second region of interest 708 may not be included on an actual display of the annotated images from the ultrasound imaging device and are only included to illustrate the regions of interest.

The first region of interest 706 is applied with a 50% highlight mask while the second region of interest 708 is applied with a 100% highlight mask. Both of the 50% and 100% highlight masks increase an intensity of the pixels within the first region of interest 706 and second region of interest 708 based on a mask of certainty of detection. For example, as the mask of certainty of detection increases (e.g., more likely to be a nerve) the effect of highlighting increases, resulting in the area becoming lighter (e.g., whiter). Due to the 100% highlight mask increasing the intensity more than the 50% highlight mask, the likely area of the nerve within the second region of interest 708 is lighter than the likely area of the nerve within the first region of interest 706. Thus, a region of interest may be identified and a likeliness of the region of interest containing a nerve may be shown on an annotated ultrasound image without attracting the same amount of attention as with colorized or overlayed images, which may be desirable to trained and experienced physicians or in situations where calling too much attention to the region of interest may result in missing other details within the ultrasound image.

Continuing to FIG. 7C, a highlighted and colored image 704 is shown with a region of interest 710. The highlighted and colored image 704 combines and applies a highlight mask and a colorization mask to the region of interest 710. For example, it may be desirable to combine effects of different masks. The region of interest 710 has a 100% highlight mask and a 50% colorization mask applied. In other examples, an overlay mask, highlight mask, and colorization mask or any combination of may be applied to the medical image.

Returning to FIG. 3, at 316, method 300 includes outputting annotated ultrasound images to a display. For example, the ultrasound images may comprise the pixel values calculated at 306, 308, 310, 312 and 314 and an annotated version of each ultrasound image that comprises overlay, colorization, and/or highlighting may be output to the display in real-time. In some examples, the display is included in the ultrasound imaging system, such as display device 118. Each annotated ultrasound image may be output in substantially real-time in the sequence acquired and at a designated display frame rate.

At 318, it is determined if the acquisition is finished. For example, the acquisition may be considered finished when ultrasound data is acquired for all of the views and/or imaging modes programmed in the ultrasound protocol and the ultrasound probe is no longer actively transmitting and receiving ultrasonic signals. Additionally or alternatively, the acquisition may be finished responsive to the processor receiving an “end protocol” input from the operator.

If the acquisition is not finished, such as when the ultrasound probe is still actively acquiring ultrasound data according to the ultrasound protocol and/or there are remaining views/imaging modes in the ultrasound protocol, method 300 returns to 304 and continues acquiring ultrasound data with the ultrasound probe according to the ultrasound protocol.

If at 318, image acquisition is determined to be finished, method 300 continues to 320, which includes saving the unannotated and annotated images to memory (e.g., the non-transitory memory 206 of FIG. 2). Further, raw, unprocessed ultrasound data may be saved, at least in some examples. The memory may be local to the ultrasound imaging system or may be a remote memory. For example, the unannotated and annotated images may be saved and/or archived (e.g., as a structured report in a PACS system) so that they may be retrieved and used to generate an official, physician-signed report that may be included in the patient’s medical record (e.g., the EHR). Method 300 may then end.

In this way, regions of interest in medical images (e.g., ultrasound images) may be identified and annotated using an overlay mask, a colorization mask, and/or a highlighting mask based on a desired quality for the annotation of the medical images. For example, if attention is desired to be brought to the region of interest the overlay mask or colorization mask may be used. As another example, if it is desired to not obscure original details of the medical images while showing a likeliness of the region of interest containing a feature (e.g., a nerve), a colorization mask may be used. As a further example, if it is desired for attention to be distributed throughout the medical image while showing a likeliness of the region of interest containing the feature, a highlighting mask may be used.

The technical effect of applying an overlay mask, a colorization mask, or a highlighting mask to medical images obtained by a medical imaging system is outputting an annotated medical image.

The disclosure also provides support for a method for annotating a medical image, comprising: segmenting a region of interest in the medical image, annotating the medical image via by separately adjusting a value of each pixel in the region of interest, and outputting the annotated medical image to a display. In a first example of the method, the medical image is a grayscale image, and wherein annotating the medical image includes a colorize factor that defines an amount of colorization to apply to a given pixel in the region of interest. In a second example of the method, optionally including the first example, annotating the medical image comprises increasing a contrast between pixels in the region of interest. In a third example of the method, optionally including one or both of the first and second examples, annotating the medical image comprises transforming each pixel in the region of interest by at least one of overlaying color in the region of interest, selectively adjusting color in the region of interest, and increasing an intensity of each pixel in the region of interest. In a fourth example of the method, optionally including one or more or each of the first through third examples, annotating the medical image comprises defining each pixel in the region of interest as a red, green, and blue vector. In a fifth example of the method, optionally including one or more or each of the first through fourth examples, separately adjusting the value of each pixel in the region of interest comprises separately adjusting the value of each pixel in the region of interest according to a certainty of detection of the region of interest at a given pixel in the region of interest. In a sixth example of the method, optionally including one or more or each of the first through fifth examples, separately adjusting the value of each pixel in the region of interest further comprises generating a mask value between a minimum value and a maximum value for each pixel in the region of interest, and wherein the mask value increases toward the maximum value as the certainty of detection of the region of interest at the given pixel increases. In a seventh example of the method, optionally including one or more or each of the first through sixth examples, separately adjusting the value of each pixel in the region of interest comprises determining a boost factor that defines a gain increase to a given pixel in the region of interest. In an eighth example of the method, optionally including one or more or each of the first through seventh examples, annotating the medical image comprises, for each pixel in the region of interest: building a highlight map based on an attention factor that defines a strength of a total masking effect, a boost factor that defines a gain increase, a colorize factor that defines an image-dependent colorization effect, a highlight factor that defines an amount of overlay color to add to the medical image, and a grayscale map of the medical image, and transforming an image power to red, green, and blue color space using the highlight map.

The disclosure also provides support for a method for medical imaging, comprising: generating a medical image from acquired medical image data, identifying a region of interest in the medical image via a segmentation algorithm, colorizing the region of interest relative to a remainder of the medical image, and displaying the medical image with a transformed region of interest. In a first example of the method, colorizing the region of interest relative to the remainder of the medical image comprises: determining a highlighting value for each pixel in the region of interest based on a certainty of identification of the region of interest at a given pixel, determining a target highlighting color in red, green, and blue color space, and masking each pixel in the region of interest according to vector mathematics of the highlighting value, the target highlighting color, and a grayscale map image power. In a second example of the method, optionally including the first example, the highlighting value increases toward maximal highlighting as the certainty increases and decreases toward no highlighting as the certainty decreases. In a third example of the method, optionally including one or both of the first and second examples, the colorizing masks each pixel in the region of interest. In a fourth example of the method, optionally including one or more or each of the first through third examples, colorizing the region of interest relative to the remainder of the medical image comprises transforming an image power of the region of interest to red, green, and blue color space and maintaining the remainder of the medical image in grayscale. In a fifth example of the method, optionally including one or more or each of the first through fourth examples, colorizing the region of interest relative to the remainder of the medical image comprises adding an overlay to the region of interest and not the remainder of the medical image.

The disclosure also provides support for a system for annotating a medical image, comprising: a processor operatively coupled to a memory storing executable instructions that, when executed by the processor, cause the processor to: identify a region of interest in the medical image via segmentation, and adjust an appearance of each pixel in the region of interest using a highlight map that is a function of a mask value and a power value. In a first example of the system, the power value of each pixel in the region of interest is extracted by a reverse operation on a red, green, and blue color space. In a second example of the system, optionally including the first example, the power value of each pixel is a boosted power value that increases a gain of a given pixel in the region of interest. In a third example of the system, optionally including one or both of the first and second examples, the mask value defines an amount of highlighting to apply to a given pixel in the region of interest between no highlighting and maximal highlighting. In a fourth example of the system, optionally including one or more or each of the first through third examples, the highlight map transforms the appearance of each pixel in the region of interest to red, green, blue color space from a grayscale map of the medical image.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for annotating a medical image, comprising:
segmenting a region of interest in the medical image;
annotating the medical image via by separately adjusting a value of each pixel in the region of interest; and
outputting the annotated medical image to a display.

2. The method of claim 1, wherein the medical image is a grayscale image, and wherein annotating the medical image includes a colorize factor that defines an amount of colorization to apply to a given pixel in the region of interest.

3. The method of claim 1, wherein annotating the medical image comprises increasing a contrast between pixels in the region of interest.

4. The method of claim 1, wherein annotating the medical image comprises transforming each pixel in the region of interest by at least one of overlaying color in the region of interest, selectively adjusting color in the region of interest, and increasing an intensity of each pixel in the region of interest.

5. The method of claim 1, wherein annotating the medical image comprises defining each pixel in the region of interest as a red, green, and blue vector.

6. The method of claim 1, wherein separately adjusting the value of each pixel in the region of interest comprises separately adjusting the value of each pixel in the region of interest according to a certainty of detection of the region of interest at a given pixel in the region of interest.

7. The method of claim 6, wherein separately adjusting the value of each pixel in the region of interest further comprises generating a mask value between a minimum value and a maximum value for each pixel in the region of interest, and wherein the mask value increases toward the maximum value as the certainty of detection of the region of interest at the given pixel increases.

8. The method of claim 1, wherein separately adjusting the value of each pixel in the region of interest comprises determining a boost factor that defines a gain increase to a given pixel in the region of interest.

9. The method of claim 1, wherein annotating the medical image comprises, for each pixel in the region of interest:
building a highlight map based on an attention factor that defines a strength of a total masking effect, a boost factor that defines a gain increase, a colorize factor that defines an image-dependent colorization effect, a highlight factor that defines an amount of overlay color to add to the medical image, and a grayscale map of the medical image; and
transforming an image power to red, green, and blue color space using the highlight map.

10. A method for medical imaging, comprising:
generating a medical image from acquired medical image data;
identifying a region of interest in the medical image via a segmentation algorithm;
colorizing the region of interest relative to a remainder of the medical image; and
displaying the medical image with a transformed region of interest.

11. The method of claim 10, wherein colorizing the region of interest relative to the remainder of the medical image comprises:
determining a highlighting value for each pixel in the region of interest based on a certainty of identification of the region of interest at a given pixel;
determining a target highlighting color in red, green, and blue color space; and
masking each pixel in the region of interest according to vector mathematics of the highlighting value, the target highlighting color, and a grayscale map image power.

12. The method of claim 11, wherein the highlighting value increases toward maximal highlighting as the certainty increases and decreases toward no highlighting as the certainty decreases.

13. The method of claim 10, wherein the colorizing masks each pixel in the region of interest.

14. The method of claim 10, wherein colorizing the region of interest relative to the remainder of the medical image comprises transforming an image power of the region of interest to red, green, and blue color space and maintaining the remainder of the medical image in grayscale.

15. The method of claim 10, wherein colorizing the region of interest relative to the remainder of the medical image comprises adding an overlay to the region of interest and not the remainder of the medical image.

16. A system for annotating a medical image, comprising:
a processor operatively coupled to a memory storing executable instructions that, when executed by the processor, cause the processor to:
identify a region of interest in the medical image via segmentation; and
adjust an appearance of each pixel in the region of interest using a highlight map that is a function of a mask value and a power value.

17. The system of claim 16, wherein the power value of each pixel in the region of interest is extracted by a reverse operation on a red, green, and blue color space.

18. The system of claim 16, wherein the power value of each pixel is a boosted power value that increases a gain of a given pixel in the region of interest.

19. The system of claim 16, wherein the mask value defines an amount of highlighting to apply to a given pixel in the region of interest between no highlighting and maximal highlighting.

20. The system of claim 16, wherein the highlight map transforms the appearance of each pixel in the region of interest to red, green, and blue color space from a grayscale map of the medical image.
